(19) United States
(12) Patent Application Publication
(10) Pub. No.: US 2010/0050882 A1
(43) Pub. Date: Mar. 4, 2010

(54) WATER-COOLED BARBECUE SYSTEM

(76) Inventor: Keun-Jin Lee, Gyeonggi-do (KR)

Correspondence Address: RATNERPRESTIA, P.O. BOX 980, VALLEY FORGE, PA, 19482, US

(21) Appl. No.: 12/514,106

(22) PCT Filed: Nov. 1, 2007
(86) PCT No.: PCT/KR2007/005488

§ 371 Date: Nov. 12, 2009

(30) Foreign Application Priority Data
Nov. 8, 2006 (KR) 10-2006-0109998

(51) Int. Cl. G07F 9/10

(52) U.S. Cl. 99/357

(57) ABSTRACT

A water-cooled barbecue system which prevents overheating of the interior thereof and a grill and also prevents leakage of water from the appliance when the operation thereof is stopped. A burner is within the main body, a grill is disposed on the upper part of the main body, water circulates in the interior of the grill, and a cooling system for cooling water is included in the barbecue system. A bimetal switch interrupts power to a solenoid gas valve at a predetermined temperature. A fan introduces outer air into the main body's interior and the bimetal switch supplies power to the fan when a predetermined temperature is sensed. A thermal sensor is mounted on a liquid pipe through which water flows out from the grill, and a micom receives data from the thermal sensor and outputs a control signal to the cooling system and the solenoid gas valve.

### TECHNICAL FIELD

The present invention relates to a water-cooled barbecue system, which prevents and protects an appliance from overheating by controlling the temperature thereof when the appliance is used for a long time, and prevents leakage of water when the appliance is stopped, thereby protecting a user from the danger of getting burned and keeping the appliance clean.

### BACKGROUND ART

Generally, a conventional barbecue system has a problem in that food is burned or adheres to a grill in the system when the food is heated by a heating source such as electricity, gas, charcoal, etc. So as to solve such a problem, the present applicant filed “water-cooled barbecue system” (patent No. 2006-0005825).

In FIGS. 9 and 10, the above-mentioned barbecue system is illustrated.

With reference to FIGS. 9 and 10, the main body 100 of the barbecue system 1 is mounted in a housing 500. A grill 300 is installed at the interior of the main body 100, and a heating part 120 is included at the lower part of the grill 300. A pipe-type burner 140 as a heating source is received in the heating part 120, and a controlling knob 150 is installed at the front part of the heating part 120 so as to control heating power.

A cooling switch part 200 is included in the center of the front part of the main body 100. The cooling switch part 200 operates a cooling apparatus 400 so as to supply cooling water to the grill 300. The cooling apparatus 400 has a lamp 130 for displaying the operating state thereof. Also, a lamp 130 is also included in the heating part 120.

Meanwhile, the housing 500 includes a cabinet 510 arranged at the lower part of the main housing 100, a shelf arranged at both sides thereof, and a cooker 530, A secondary shelf 522, which is received in a sliding-type manner, is included on the inner side of the shelf 520. The housing 500 includes a cap 570 covering the upper side of the main housing 100 at the upper part thereof. The housing 500 includes a leg 540 at the lower part thereof. The first wheel 550 and the second wheel 560 are assembled with the leg 540. The first wheel 550 includes a stopper 551 for stopping movement of the housing 500. A sliding shelf 113 for receiving a fuel tank 110 is included at the interior of the cabinet 510.

Hereinafter, with reference to FIGS. 9 and 10, the operation of a conventional barbecue system will be described.

A grill 300 is disposed at the upper part of the main body 100, and the cooling switch part 200 is operated. Then, water is supplied from the cooling apparatus 400 to the grill 300. Next, the controlling knob is rotated so as to ignite the burner. As a result, water circulates along the grill 300 while the barbecue grill is used. Therefore, food is not burned or does not adhere to the grill while being heated.

However, the conventional barbecue system has a problem as described below.

When the barbecue grill is covered by a cap 570 and is heated for long time, the temperature of the interior of the barbecue grill and a control panel part increases. Therefore, it is possible to cause a fire and/or damage to electronic components.

Also, when the grill is heated for long time, the temperature of water circulating in the interior of the grill increases so that the grill can not be effectively cooled. Therefore, food can adhere to the grill while being cooked.

Meanwhile, when the operation of the barbecue grill is stopped, water is discharged by the pressure remaining in the pump, thereby causing a user to easily get burned and getting the appliance dirty.

### DISCLOSURE OF INVENTION

### Technical Problem

Accordingly, the present invention has been made to solve the above-mentioned problems occurring in the prior art, and the present invention provides a water-cooled barbecue system, which prevents damage to electronic components and/or the occurrence of a fire caused by an increase of the temperature of a control panel part or the interior of the main body when the barbecue grill is used for long time in an airtight state.

Also, the present invention provides a water-cooled barbecue system which keeps the temperature of water circulating through the interior of a grill within a predetermined range so as to prevent overheating of the grill.

Also, the present invention provides a water-cooled barbecue system which prevents the leakage of water caused by the remaining pressure of the pump when the operation of the barbecue grill is stopped, thereby protecting a user from getting burned and keeping the barbecue grill clean.

### Technical Solution

In accordance with an aspect of the present invention, there is provided a water-cooled barbecue system including: a main body 10 which has an upper part opened and a space for receiving a burner in the interior of the main body; a grill 30 disposed on the upper part of the main body 10, the grill 30 having a space in the interior of the grill 30; a cooling system which circulates water in the interior of the grill 30 so as to cool the grill 30, the cooling system being connected through the grill 30 and a liquid pipe 74; a solenoid gas valve 24 for controlling the amount of gas supplied to the burner; and a bimetal switch which blocks off power supplied to the solenoid gas valve 24 so as to close the solenoid gas valve 24 when the temperature of the interior of the main body 10 reaches a predetermined temperature.

The water-cooled barbecue system further includes a fan 60 which is included on the outer side of the main body 10 so as to introduce outer air to the interior of the main body 10.

A control panel part is included in the interior of the main body 10 so as to control each operation of the cooling system and the burner, and a bimetal switch is included in the control panel part so as to supply power to the fan 60 when the temperature of the control panel part reaches a predetermined temperature.

Check valves 80 and 90, which are opened toward only one direction, are included in the liquid pipe 74 through which water flows into the grill 30.

The check valve 80 includes: a main body having both ends connected with the liquid pipe 74; a supporting part 81 included at a side of an inner circumferential surface of the main body, through which water flows in; a valve 86 which is movably provided in the interior of the main body while having a predetermined interval from an inner circumferential surface of the main body, and is arranged at a rear position in comparison with the supporting part 81, based on the direction of water flowing; a valve cap 82 which is included at a side of the interior of the main body through which water flows out, and which has a hole for allowing water to pass; and a spring 84 which is provided between the valve 86 and the valve cap 82, and has a coefficient of elasticity within a range bigger than the pressure of water circulated by the remaining pressure of the pump 42 and smaller than the pressure of water circulated by operation of the pump 42.

A packing 88 is mounted on a periphery of the valve 86.

The check valve 90 includes: an upper main body 91 which has both ends connected with the liquid pipe 74 and has a first partition 101 provided at an inner circumferential surface of the upper main body toward a lower direction; a lower main body 92 which is arranged at a lower part of the upper main body 91, has both ends connected with the liquid pipe 74, and has a second partition 103 provided at a side of an upper part of the lower main body, from which water flows in, toward a lower direction; a cap 99 which is assembled with the lower part of the lower main body 92 and has a central part protruding toward the exterior; a piston 94 which is included in the interior of the lower main body 92, has a head part positioned toward the first partition 101 and the second partition 103, and has a shaft received in the central part of the cap 99; a spring 98 which is arranged at an end of the shaft of the piston 94 and has a coefficient of elasticity bigger than pressure of water circulated by remaining pressure of the pump 42; and a solenoid 96 which is arranged at a lower part of the lower main body 92, which is on the outer side of the central part of the cap 99, and pulls the head part of the piston 94 due to applied power

A packing 95 is mounted between the lower main body 92 and the cap 99.

The water-cooled barbecue system further includes: a thermal sensor 72 mounted on the liquid pipe 74 through which water flows out from the grill 30 so as to sense the temperature of water discharged from the grill 30; and a micom 70 which receives data from the thermal sensor 72 so as to output a control signal to the cooling system and the solenoid gas valve 24.

The micom 70 outputs a control signal so as to allow the fan 60 to operate at a low speed when the temperature of water reaches a first temperature, outputs a control signal so as to allow the fan 60 and the pump 42 to operate at a high speed when the temperature of water reaches a second temperature, outputs a control signal so as to allow the gas valve 24 to reduce the amount of supplied gas when the temperature of water reaches a third temperature, and outputs a control signal so as to allow the gas valve 24 to cut off supplying gas when the temperature of water reaches a fourth temperature.

### Advantageous Effects

As described above, according to the present invention, when the barbecue system is used for a long time in an airtight state, it is possible to prevent damage to electronic components and/or the occurrence of a fire caused by an increase of the temperature of the control panel part and the interior of the main body.

Also, according to the present invention, the temperature of water circulating through the interior of the grill is kept within a predetermined range, thereby preventing overheating of the grill.

Also, according to the present invention, when the operation of the barbecue grill is stopped, it is possible to prevent water from leaking due to the remaining pressure of the pump. Therefore, the user can be protected from getting burned, and the appliance can be kept clean.

### BRIEF DESCRIPTION OF THE DRAWINGS

The above and other objects, features and advantages of the present invention will be more apparent from the following detailed description taken in conjunction with the accompanying drawings, in which:

FIG. 1 is a front view illustrating a barbecue system according to an embodiment of the present invention;

FIG. 2 is a side view illustrating the barbecue system as shown in FIG. 1;

FIG. 3 is a schematic view illustrating a cooling system according to the present invention;

FIG. 4 is a sectional view illustrating a check valve according to the first embodiment of the present invention, in which the check valve is opened;

FIG. 5 is a sectional view illustrating the check valve according to the first embodiment of the present invention, in which the check valve is closed;

FIG. 6 is a sectional view illustrating a check valve according to the second embodiment of the present invention, in which the check valve is opened;

FIG. 7 is a sectional view illustrating the check valve according to the second embodiment of the present invention, in which the check valve is closed;

FIG. 8 is a front view illustrating a barbecue system according to another embodiment of the present invention;

FIG. 9 is a front perspective view illustrating a conventional barbecue system; and

FIG. 10 is a side perspective view illustrating the barbecue system as shown in FIG. 9.

### MODE FOR THE INVENTION

Hereinafter, exemplary embodiments of the present invention will be described with reference to the accompanying drawings.

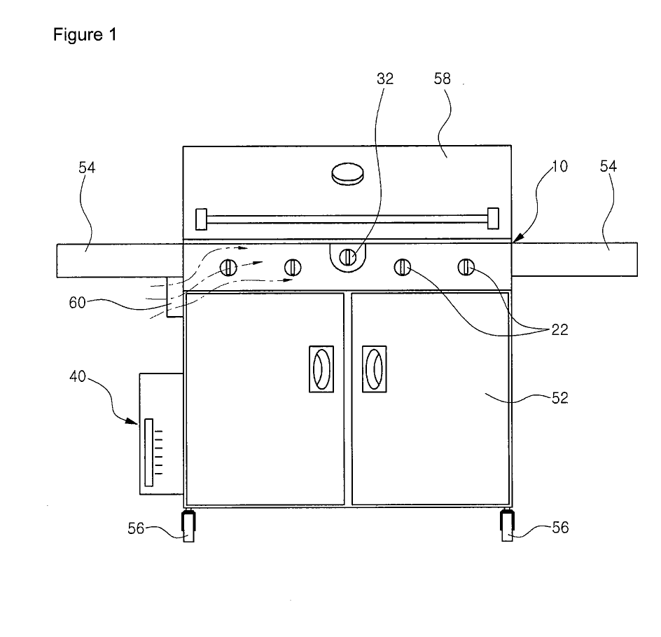

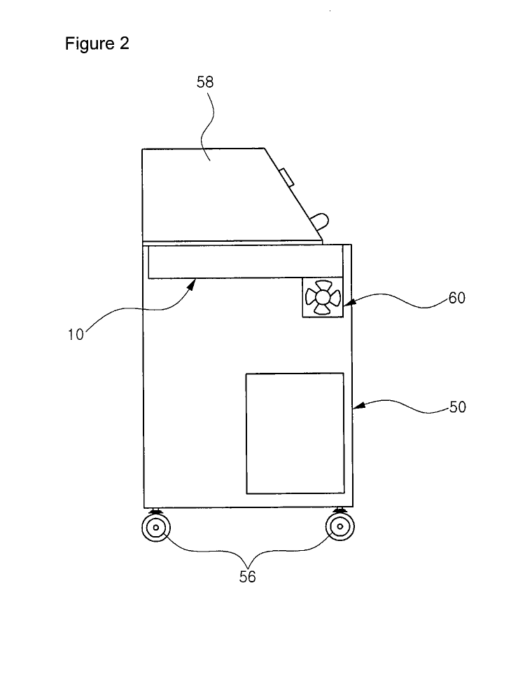

In FIGS. 1 and 2, a barbecue system according to one embodiment of the present invention is described.

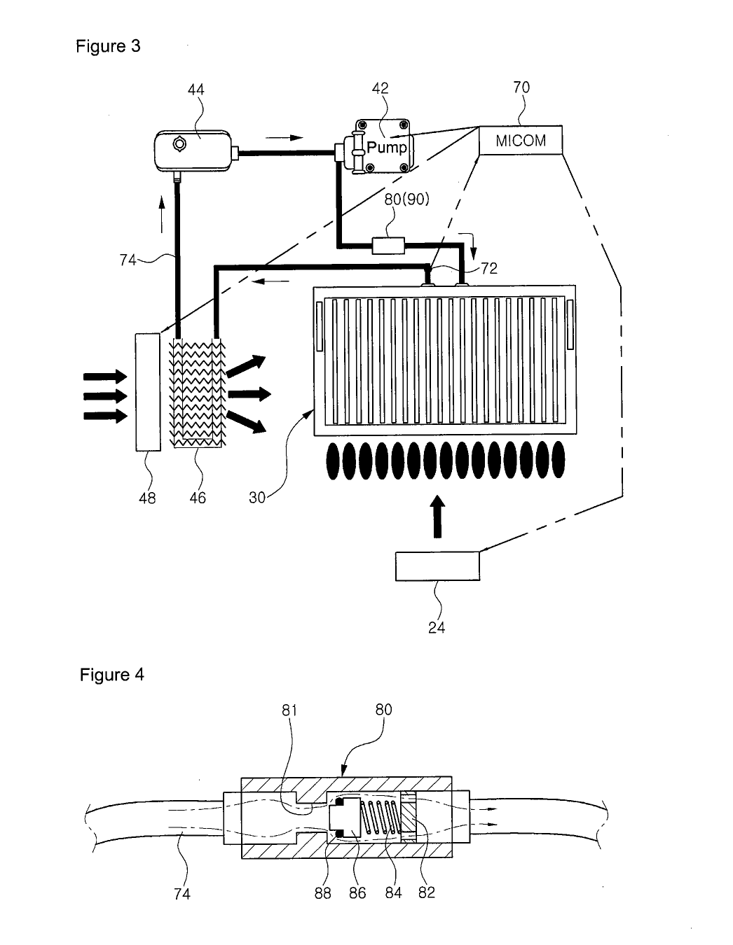

The main body 10 of the barbecue grill is mounted on a housing 50 which can move. The main body 10 has an upper part thereof opened, and a grill 30 (refer to FIG. 3) is disposed on the opened upper part thereof. The upper part of the main body is opened/closed by a cover 58. A burner (not shown) as a heating source is received in the interior of the main body 10. Therefore, the burner is arranged at the lower part of the grill 30. A heating power control knob 22 for controlling heating power of the burner is installed at the outer side of the main body 10. A solenoid gas valve 24 (refer to FIG. 3), which controls the amount of gas supplied to the burner, is included in the burner.

The housing 50 includes a cabinet 52 arranged at the lower part of the main body and a shelf 54 arranged at a side surface of the main body. Wheels 56 are included at the lower part of the cabinet 52. A fan 60 is mounted at the outer side of the housing 50. The fan 60 introduces outer air to the interior of the main body 10.

Meanwhile, the grill 30 has a pipe-shape and an inner space provided therein. Water circulates in the inner space of the grill 30. A cooling switch part 32 is included at the outer side of the main body 10 so as to control the circulation of water. According to the operation of the cooling switch part 32, water circulates in a cooling apparatus and the grill 30. The cooling apparatus is included at the interior of a cooling kit 40 mounted on the outer side of the cabinet 52.

Also, the main body has a panel part (not shown) for controlling the operation of the cooling apparatus and the burner.

In order to use a barbecue system constructed as described above, the cooling switch part 32 is operated so as to circulate water in the grill 30. The heating power control knob 22 is operated so as to ignite the barbecue grill, and then food is cooked. Then, water is supplied from the cooling apparatus to the grill 30 and circulates the interior of the grill 30. Water is discharged from the grill 30, is cooled while passing the cooling apparatus, and is again supplied to the grill 30.

Herein, when the grill 30 is heated for long time in a state where the grill is covered by the cover 58, the temperature of the interior of the main body 10 and the temperature of the control panel part increase. In this case, the method for maintaining the temperature of the interior of the main body 10 and the control panel part will be described below.

Although not shown, a bimetal switch is arranged between the solenoid gas valve 24 and a power source. This bimetal switch reacts when it reaches a predetermined temperature, e.g. a temperature which can cause damage to electronic components or the occurrence of a fire. Therefore, the bimetal switch cuts off the power supplied to the solenoid gas valve 24 when the temperature of the interior of the main body reaches the predetermined temperature mentioned above. Accordingly, when the solenoid gas valve 24 is cut off, gas isn t supplied to the burner. Then, the interior of the main body 10 is not heated, so that the temperature of the interior of the main body 10 decreases as time goes by. According to such a method, the temperature of the interior of the main body 10 can be kept under a predetermined temperature.

Also, although not shown, a bimetal switch reacting at a predetermined temperature, for example at 75° C. is installed at the control panel part of the interior of the main body 10. This bimetal switch is used so as to apply/cut off power supplied to the fan 60. When the temperature of the control panel part reaches 75° C., the bimetal switch connects power to the fan 60. Therefore, the fan 60 is operated so as to introduce outer air to the control panel part and cool it. After that, when the temperature of the control panel drops under 75° C., the bimetal switch blocks off power supplied to the fan 60. According to such a scheme, the temperature of the control panel part is kept under a predetermined temperature (e.g. 75° C.).

In FIG. 3, a cooling system according to the present invention will be schematically illustrated.

The cooling system includes a thermal sensor mounted at a liquid pipe 74 through which the water flows out from the grill 30 so as to sense the temperature of the water, a micom 70 for receiving data from the thermal sensor 72 so as to output a control signal, and pumps 42 operated by the control signal received from the micom 70, a fan 48, and a solenoid gas valve 24. The cooling system includes a water tank 44 and a heat exchanger 46. Also, the liquid pipe 74 forms a water supplying pipe connected from the water tank 44 to the grill 30 while passing the pumps 42, and a water returning pipe connected from the grill 30 to the water tank 44 while passing the heat exchanger 46. Meanwhile, check valves 80 and 90 are included in the liquid pipe 74 through which water flows into the grill 30.

The operation of the cooling system constructed as described above will be described below.

The cooling switch part 32 of the barbecue grill is operated, and the burner is ignited. Then, while the pump 42 is operated at a low speed, water is supplied from the water tank 44 to the grill 30. The water discharged after circulating through the grill 30 is cooled while passing the heat exchanger 46. The fan 48 is arranged at the periphery of the heat exchanger 46 so as to accelerate cooling water. Then, water is kept in the water tank 44 and again circulated as described above.

However, when the grill 30 is heated for a long time, the temperature of the water gradually increases so that the grill 30 can not be efficiently cooled. Therefore, so as to maintain a certain temperature of the water, a control has to be performed by the micom 70.

The thermal sensor 72 senses the temperature of water in the liquid pipe 74 through which water is discharged from the grill 30 and sends the data of the temperature to the micom 70 (S1). When the temperature of water reaches the first temperature, e.g. 60° C., the micom 70 outputs a control signal for operating the fan 48. Then, the fan 48 operates at a low speed so as to prevent the temperature of water from increasing any more. At this time, step S1 is successively performed so as to allow the micom 70 to output a control signal.

After that, when the temperature of water drops under 60° C., the micom 70 outputs a control signal for stopping the operation of the fan 48 (S3). However, if the temperature of water does not decrease but increases and reaches the second temperature, e.g. 80° C., in time, the micom 70 outputs a control signal for increasing the level of power to the pump 42 and the fan 48. Then the pump 42 operates at a high speed so as to supply liquid to the grill 30, the fan 48 operates at a high speed so as to rapidly cool the liquid.

After that, when the temperature of the water drops under 80° C., the micom 70 outputs a control signal for operating the fan 48 and the pump 42 at a low speed (S5). However, if the temperature of water does not decrease but reaches the third temperature (a critical temperature), e.g. 90° C. although time goes by, the micom 70 outputs a control signal for reducing the amount of supplied gas to the solenoid gas valve 24 (S6). At this time, the pump 42 and the fan 48 operate at a high speed. Herein, step S6 is maintained until the temperature of water drops under 80° C. After that, when the temperature of water drops under 80° C., the micom 70 stops step S6 and performs step S5.

However, if the temperature of water does not decrease but reaches the fourth temperature (a dangerous temperature), e.g. 100° C., in time, the micom 70 outputs a control signal for blocking off the solenoid gas valve 24 (S7). Step S7 is also maintained until the temperature of water drops under 80° C. After that, when the temperature of water drops under 80° C., the micom 70 outputs a control signal for supplying gas to the solenoid gas valve 24 (S8), reignites the burner, and returns to step S5. At this time, in a case where the burner is reignited in step S8, the case where the user reignites it can be included.

According to such a scheme, the temperature of the water of the interior of the grill 30 is always kept at the fourth temperature, e.g. under 100° C. While the grill 30 is heated, the temperature of the water is controlled according to the above described steps. As such, when the temperature of the water is kept within a predetermined range, the grill 30 is not overheated while food is cooked so that food does not adhere to the grill 30 and is not burned.

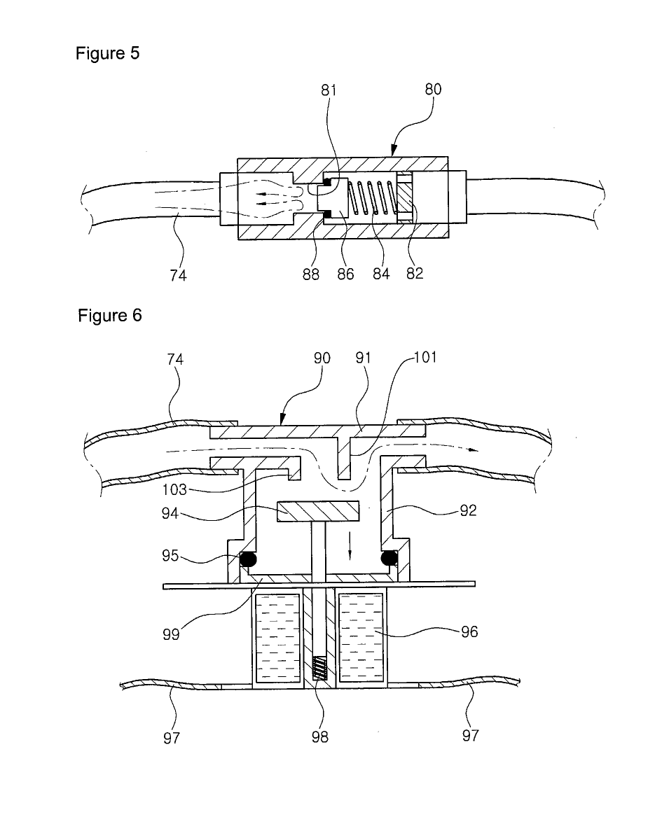

In FIGS. 4 and 5, a check valve according to the first embodiment of the present invention will be illustrated.

The main body of the check valve 80 has both ends connected to the liquid pipe 74. A supporting part 81 is included in the inner circumferential surface of the main body. Based on the direction of water flowing, a valve 86 is provided on the side of the interior of the main body, into which water flows, and a valve cap 82 is included on the side thereof, out of which water flows. The valve 86 is arranged while having a pre-determined interval with the inner circumferential surface of the main body so that it freely moves within the main body, and is arranged at the rear side in comparison with the supporting part 81, based on the direction of water flowing. A packing 88 is mounted on the periphery of the valve 86. A spring 84 is provided between the valve 86 and the valve cap 82. Therefore, the valve 86 makes contact with the supporting part 81 by means of the elastic force of the spring 84.

The valve cap 82 has a hole allowing water to pass through. The operation of the check valve 80 according to the first embodiment, which is constructed as described above, will be described below.

With reference to FIG. 4, when water is supplied to the grill 30 by the pump 42, the valve 86 is pushed by pressure of water and is separated from the supporting part 81 so that a pipe is formed in the interior of the main body. Then, water passes the periphery of the valve 86 and passes through the hole of the valve cap 82. At this time, because the pressure of water is higher than the elastic force of the spring 84, the pressure of the water can push the valve 86.

Meanwhile, with reference to FIG. 5, when the operation of the pump 42 is stopped, water flows into the liquid pipe 74 due to the remaining pressure of the pump 42 so as to reach the entrance of the check valve 80. However, in this case, the pressure of water is lower than the elastic force of the spring 84 so that it can not push the valve 86. Therefore, in a case where the operation of the barbecue grill is stopped, although water flows into the liquid pipe 74 due to remaining pressure of the pump 42, the water is not discharged to the exterior due to the check valve 80.

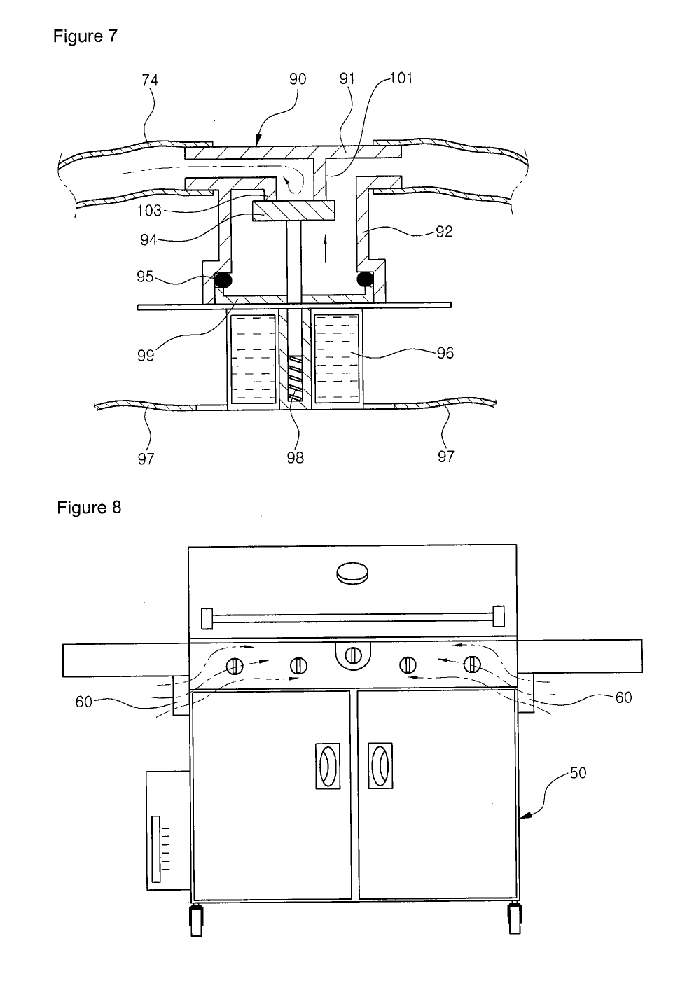

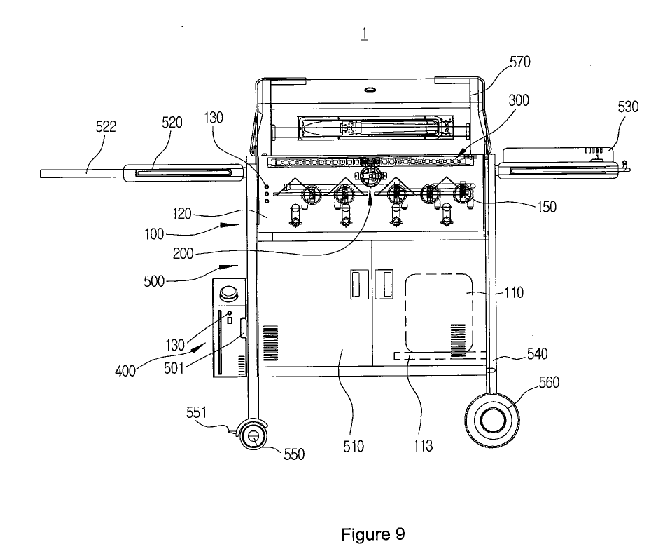

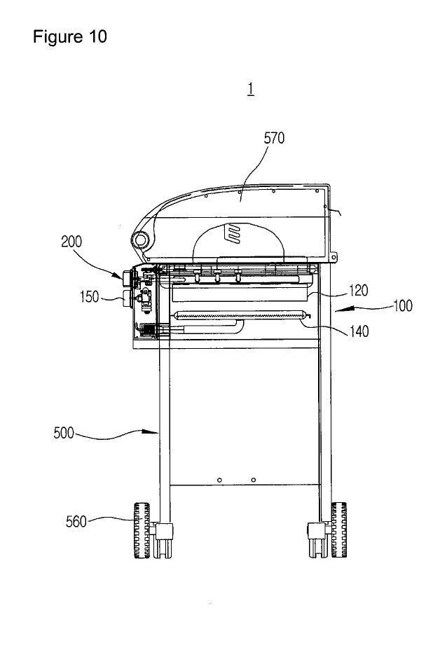

In FIGS. 6 and 7, a check valve according to the second embodiment of the present invention will be illustrated.

The check valve 90 according to the second embodiment includes an upper main body 91, a lower main body 92, and a solenoid 96. Both ends of the upper main body 91 and both ends of the lower main body 92 are connected to the liquid pipe 74, respectively. The first partition 101 is included in the upper main body 91 toward a lower direction thereof, and the second partition 103 is included in the upper part of the lower main body 92, which is positioned at a side from which water flows, toward a lower direction thereof. A cap 99 having a central part protruding to the exterior is assembled with the lower part of the lower main body 92. A packing 95 is provided between the lower main part 92 and the cap 99. The solenoid 96 is arranged around the central part of the cap 99. A piston 94 is provided in the interior of the lower main body 92. The piston 94 has a head part making contact with the first partition 101 and the second partition 103, and a shaft thereof is received in the central part of the cap 99 and is arranged at a central position inside the solenoid 96. The spring 98 is wound on an end of the shaft of the piston 94. A guide wire 97 is provided in the solenoid 96 so as to be connected to the power.

The operation of the check valve 90 according to the second embodiment, which is constructed as described above, will be described below.

With reference to FIG. 6, so as to supply water to the grill 30, when power is applied to the solenoid 96, the head part of the piston 94 moves toward the solenoid 96. Accordingly, the head part of the piston 94 is separated from the first and second partitions 101 and 103 that a water pipe is formed. Therefore, water can flow toward the grill 30 while passing through the check valve 90.

Meanwhile, with reference to FIG. 7, so as to stop supplying water, when supplying power to the solenoid 96 is blocked off, the piston 94 is not influenced by attraction of the solenoid 96. Therefore, the piston 94 receives elastic force of the spring 98 so that the head part thereof makes contact with the first and second partitions 101 and 103. In this case, because the pressure of water is smaller than elastic force of the spring 98, the pressure of water can not move the piston 94. Therefore, although water flows into the liquid pipe 74 due to the remaining pressure of the pump 42, the water does not flow out due to the check valve 90.

In FIG. 8, the barbecue system according to another embodiment of the present invention will be illustrated.

The barbecue system as shown in FIG. 8 has the same structure as the barbecue system as shown in FIG. 1, except that there are two fans 60 mounted on an outer side of the housing 50. Also, as the operation of the barbecue system is the same as the operation of the barbecue system as shown in FIG. 1, a description will be omitted.

According to the barbecue system constructed as described above, two fans 60 introduce outer air to the control panel part so as to cool it, thereby securing better efficiency in cooling in comparison with the barbecue system as shown in FIG. 1.

As described above, according to the present invention, when a barbecue grill is used for long time in an airtight state, it is possible to prevent damage to electronic components and/or the occurrence of a fire caused by an increase of the temperature of the interior of the main body and the control panel part.

Also, according to the present invention, the temperature of the water circulating in the interior of the grill is kept within a predetermined range, thereby preventing overheating of the grill.

Also, according to the present invention, when the operation of the barbecue grill is stopped, it can be prevented that water flows out due to the remaining pressure of the pump. Therefore, the user can be protected from burns, and the appliance can be kept clean.

Although an exemplary embodiment of the present invention has been described for illustrative purposes, those skilled in the art will appreciate that various modifications, additions and substitutions are possible, without departing from the scope and spirit of the invention as disclosed in the accompanying claims.

1. A water-cooled barbecue system comprising:
a main body which has an upper part opened and a space for receiving a burner in an interior of the main body;
a grill disposed on the upper part of the main body, the grill having a space in an interior of the grill;
a cooling system which circulates water through the interior of the grill so as to cool the grill, the cooling system being connected with the grill through a liquid pipe;
a solenoid gas valve for controlling the amount of gas supplied to the burner; and
a bimetal switch which blocks off power supplied to the solenoid gas valve so as to close the solenoid gas valve when the temperature of the interior of the main body reaches a predetermined temperature.

2. The water-cooled barbecue system as claimed in claim 1, further comprising a fan which is included on the outer side of the main body so as to introduce outer air to the interior of the main body.

3. The water-cooled barbecue system as claimed in claim 2, wherein a control panel part is included in the interior of the main body so as to control each operation of the cooling system and the burner, and a bimetal switch is included in the control panel part so as to supply power to the fan when the temperature of the control panel part reaches a predetermined temperature.

4. The water-cooled barbecue system as claimed in claim 1, wherein a check valve, which is opened toward only one direction, is included in the liquid pipe through which water flows into the grill.

5. The water-cooled barbecue system as claimed in claim 4, wherein the check valve comprises:
a main body having both ends connected with the liquid pipe;
a supporting part included at a side of an inner circumferential surface of the main body, through which water flows in;
a valve which is movably provided in the interior of the main body while having a predetermined interval from an inner circumferential surface of the main body, and is arranged at a rear position in comparison with the supporting part, based on the direction of water flowing;
a valve cap which is included at a side of the interior of the main body through which water flows out, and has a hole for allowing water to pass; and
a spring which is provided between the valve and the valve cap, and has a coefficient of elasticity within a range higher than the pressure of water circulated by the remaining pressure of the pump and lower than the pressure of water circulated by operation of the pump.

6. The water-cooled barbecue system as claimed in claim 5, wherein a packing is mounted on a periphery of the valve.

7. The water-cooled barbecue system as claimed in claim 4, wherein the check valve comprises:
an upper main body which has both ends connected with the liquid pipe and has a first partition provided at an inner circumferential surface of the upper main body toward a lower direction;
a lower main body which is arranged at a lower part of the upper main body, has both ends connected with the liquid pipe, and has a second partition provided at a side of an upper part of the lower main body, from which water flows into, toward a lower direction;
a cap which is assembled with the lower part of the lower main body and has a central part protruding toward the exterior;
a piston which is included in the interior of the lower main body, has a head part positioned toward the first partition and the second partition, and has a shaft received in the central part of the cap;
a spring which is arranged at an end of the shaft of the piston and has a coefficient of elasticity higher than the pressure of water circulated by the remaining pressure of the pump; and
a solenoid which is arranged at a lower part of the lower main body, which is on the outer side of the central part of the cap, and pulls the head part of the piston due to applied power.

8. The water-cooled barbecue system as claimed in claim 7, wherein a packing is mounted between the lower main body and the cap.

9. The water-cooled barbecue system as claimed in claim 1, further comprising:
a thermal sensor mounted on the liquid pipe through which water flows out from the grill so as to sense the temperature of water discharged from the grill; and
a micom which receives data from the thermal sensor so as to output a control signal to the cooling system and the solenoid gas valve.

10. The water-cooled barbecue system as claimed in claim 9, wherein the micom outputs a first control signal so as to allow the fan to operate at a low speed when the temperature of water reaches a first temperature, outputs a second control signal so as to allow the fan and the pump to operate at a high speed when the temperature of water reaches a second temperature, outputs a third control signal so as to allow the gas valve to reduce the amount of supplied gas when the temperature of water reaches a third temperature, and outputs a fourth control signal so as to allow the gas valve to cut off supplying gas when the temperature of water reaches a fourth temperature.
